(19) United States
(12) Patent Application Publication
(10) Pub. No.: US 2012/0282315 A1
(43) Pub. Date: Nov. 8, 2012

(54) COMPOSITIONS AND METHODS FOR MAKING ANIMAL ATTRACTANT AND METHODS AND SYSTEMS FOR DEPLOYING ANIMAL ATTRACTANT

(76) Inventor: Jeff Tate, Hardingsburg, KY (US)

(21) Appl. No.: 13/287,829

(22) Filed: Nov. 2, 2011

Related U.S. Application Data
(60) Provisional application No. 61/456,165, filed on Nov. 2, 2010.

(51) Int. Cl. A01N 63/00; A01N 25/08; A01P 19/00

(52) U.S. Cl. 424/409; 424/84

(57) ABSTRACT

The present invention provides a method for making a storable and deployable game attractant and the resulting composition. Ground animal bone creates a base bone powder that is processed into a storable and deployable attractant product that may be transported to a location and deployed for attracting game animals. The attractant product may be combined with at least one of the group consisting of a talc-based substance, a gland powder, and any other animal attractant. The attractant product may be applied to one of a group consisting of wicks, scent pads, and wafers. The attractant product may include a cover scent adapted to cover the scent of a human and/or a burn promoting substance to promote deployment of the attractant product. The attractant product may be processed into a form from the group consisting of a solid, a powder, a liquid, a gel, and a paste.

### CROSS-REFERENCE TO RELATED APPLICATIONS

This application claims priority to U.S. Prov. App. No. 61/456,165 (Tate) entitled Compositions and Methods For Making Animal Attractants and Methods and Systems for Deploying Animal Attractant, which is incorporated herein in its entirety by reference.

### FIELD OF THE INVENTION

The present invention relates generally to compositions and methods for making animal attractant. The present invention also relates to methods and systems for deploying animal attractants such as, for example, for purposes of hunting.

### BACKGROUND OF THE INVENTION

Those who work closely with or interact with animals, such as pet owners, zoo keepers or custodians, hunters, nature preserve rangers, and others, often desire to attract animals to desired locations. Many animals, including deer, elk, moose, caribou, ibex, goats, pronghorn, sheep, and antelope (hereafter referred to collectively as “game”), possess highly developed and effective senses, including the sense of smell, that enable them to detect the presence of food, other animals, including man, and perceived dangerous conditions. For example, game can sense the presence of man and for this reason hunters and others attempt to position themselves “downwind” of the game they hunt or otherwise “cover” or obscure their scent to prevent scaring the animal away from them. Male game animals can also sense the presence of females for mating and other male animals who pose the threat of conflict as well as competition with females of the same species.

Historically hunters have had to “lie in wait” for long periods of time hoping that game will wander into their area of surveillance. Hunters often track game and try to anticipate locations that game will appear. However, much time is wasted waiting for an animal to appear. To enhance the prospect of encountering game, hunters use attractants to lure game to locations within range of firearms, bow and arrow, etc. This technique, which may be referred to as “baiting” a location, could be also employed on a commercial basis. Additionally, and in the alternative, substances may be used to discourage animals from coming to a location and act as a repellant. An attractant may be used to lure animals, e.g., bears, away from populated areas and a repellant may be used to generally ward off undesired animals.

In addition to hunting considerations, sites for attracting animals include but are not limited to parks, zoos, commercial safaris, and any other site (commercial or otherwise) intended for public and private viewing, photography, or hunting.

Known methods for attracting animals include products from Deerquest.com, which uses an oil-based smoke in combination with a first composition of eight different smells to cover the scent of human hunters and a second composition made up of two chemical smells that serve as a sexual attractant to the animal by simulating the smell of a female animal, deer, in condition for mating. By attracting the game animal to the location of the smoke, the hunters lure the game in close range of the firearm or bow and arrow. U.S. Pat. Nos. 5,618,548 and 5,914,119 disclose this type of method and composition.

Additionally, products, such as those available via mooreoutdoors.net, use aspects of the game, e.g., deer antler-based solution to train hunting dogs to retrieve antlers shed by game animals.

Other attractants include animal urine, naturally occurring food sources. It is also known that the sound of rattling antlers can serve to attract deer. In addition to attracting animals, certain substances that serve as attractants have the effect of “calming” the animal to remove concern of sources of danger, like the presence of hunters.

What is needed is an improved game attractant to better lure game and other animals to desired locations, e.g., for hunting.

### SUMMARY OF THE INVENTION

The present invention provides an attractant for animals, including deer, elk, moose and other game animals. More specifically, the present invention encompasses methods and systems for better attracting animals to, or repelling them away from, desired locations. The invention is useful in a wide variety of settings, including in parks, zoos, commercial safaris, the wild, and any other site used for viewing, hunting, photography, etc. Intended purposes and functions include attracting animals to a particular location and/or away from other locations, and/or to promoting environmental safety and sustainability, as well as other functions readily appreciated by one of ordinary skill in the art. In addition to its novel and nonobvious solutions to the problems mentioned above, the present invention also encompasses the recognition of those previously unidentified problems in the art.

Rut is the mating season of ruminant animals, such as deer, elk, moose, caribou, ibex, goats, pronghorn, sheep, and antelope. During rut male animals, e.g., bucks, grind their antlers or horns against trees and other objects and also grind their antlers against the antlers of rival animals when they fight each other for dominance. During rut season animals, such as deer, are more active and less cautious and are, therefore, easier prey for hunters.

Deer are attracted to a particular burning smell that occurs when deer fight and rub and grind their antlers against one another. The invention contemplates processing animal bone product, e.g., deer or other animal antler or bone, to generate product, e.g., powder, that replicates the burning smell generated when two male deer fight and grind antlers together. The manufactured product may then be combined with other ingredients to aid in the delivery aspect of the invention. As opposed to liquids that are simply applied to the ground or on tree bark or on other objects, the invention is preferably suspended for some amount of time in air and propogated along the path of prevailing wind or wind-assisted device.

In a first embodiment the invention provides a method for making a storable and deployable game attractant comprising: using a manufacturing process to grind an animal bone into a base bone powder, the base bone powder having a persistent odor that replicates a burnt antler smell associated with grinding antlers of male animals; processing the base bone powder into a storable and deployable attractant product; whereby the attractant product may be transported to a location and deployed for attracting game animals. The method may further comprise combining the base bone product with at least one of the group consisting of a talc-based substance, a gland powder, and an other animal attractant. The method may be processed so that the attractant product enables a persistent airborne presence when deployed. Processing the base bone product may include applying the base bone product to one of a group consisting of wicks, scent pads, and wafers. The method may further comprise processing the attractant product to include a cover scent adapted to cover the scent of a human. The method may further comprise applying a burn promoting substance to promote deployment of the attractant product and the burn promoting substance may be adapted to cause a smoking dispersal of the attractant product when a flame source is applied to the attractant product. The attractant product may be processed into a form from the group consisting of a solid, a powder, a liquid, a gel, and a paste.

In another embodiment the invention provides a game animal attractant composition comprising: a bone powder derived from the bone of a game animal ground to a powder form and processed to yield a fixed form attractant that when deployed exhibits an odor that replicates a burnt antler smell of a ruminant game animal.

In another aspect, the invention further contemplates a method for disseminating the manufactured product in a controlled fashion to bait an area and lure game animals to a desired location.

In another aspect, the invention further contemplates combining the manufactured product with a visual attractant, e.g., smoke or air-born debris, to further entice the game animal to the desired location.

In another aspect, the invention further contemplates combining the manufactured product with an aural attractant, e.g., the sound of rattling antlers, to further entice the game animal to the desired location.

In another aspect, the invention further contemplates combining the manufactured product with a cover scent to mask the smell of a human hunter to further entice the game animal to the desired location.

### BRIEF DESCRIPTION OF DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a flow chart showing an overview of the manufacturing and deployment process for a first embodiment of the invention.

### DETAILED DESCRIPTION OF PREFERRED EMBODIMENT

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

As discussed above, during rut (mating season) male deer fight and in the process grind their antlers together. Antlers are bone and while growing are covered with highly vascular skin called velvet, which supplies oxygen and nutrients to the growing bone. Upon achieving its full size, the antler bone loses its velvet and dies. The dead bone structure is referred to as a mature antler. Deer, and other such animals, shed mature antlers after each mating season.

In the wild, a particular burning smell occurs when deer fight and rub and grind their antlers against one another. Once they are done fighting the burning smell does not stay on the antler for a sustained period of time. The friction and grinding action of the fighting results in a burnt, bone smell that has been found to be an attractant to animals. For instance, if a third deer senses, through smell, that two rival deer are fighting then this will arouse interest in the third deer and attracts him to the source of the smell for the purposes of engaging the rivals. It is important to note that simply crushing antlers or other animal product does not result in the burning smell and it is not simply the smell of antler or bone that is desired but more particularly the smell or scent of burning bone/antler as experienced in the wild when male deer battle. The invention contemplates processing animal product, e.g., deer or other animal antler or bone, to generate product, e.g., powder, that replicates the burning smell generated when two male deer fight and grind antlers together. In one embodiment, the invention involves grinding animal bone, e.g., deer antler or bone, with a metal grinding wheel to produce fine burnt smelling powder “bone product.” A vacuum or other suitable device may be used to collect the fine particulate bone product, such as through a very fine filter. The powder retains the burnt smell from the grinding process. The manufactured product may then be combined with other ingredients to aid in the delivery aspect of the invention or to aid in the attractant nature of the bone product. In addition, the invention fully contemplates man-made scents designed to replicate the smell of burnt antler/bone for use as an attractant, either alone or in combination with natural antler/bone material.

In one embodiment of the invention, the ground antler/bone product (bone powder) is collected from the vacuum filter and is mixed with a talc powder. One exemplary form of this powder has no smell and is of the type that has been used, e.g., in a product called WINDACTOR available at Bass Pro Stores. This fine talc-based product is used by hunters to find the direction of the wind and in particular may be used when trying to “rattle in a buck”—this is when hunters take two antlers and “rattle” them together to give off the sound of two bucks engaged in fighting. The bond powder and talc powder are mixed together, e.g., at a 50/50 mix. Using, e.g., a funnel, the mixture may be poured in a bottle. For instance, the mixture may be packaged in a bottle with a flip lid. A two-ounce bottle is of the size that fits well in the front pocket of a hunter's shirt or jacket. The combined mixture yields a powder for determining wind direction and for spreading a friction, burnt antler smell of two bucks fighting.

Also, additional components may be added to the mixture. For example, “gland lure” (also known as pre-orbital gland lure), urine scent, tarsal gland scent, infringement scents may be added. Pre-orbital gland is a gland in front of the animal's eye that secrets an oily substance in the eye-area. Bucks, e.g., may be able to identify other bucks based on the gland scent left behind when rubbing the eye on objects, e.g., a licking branch. This oil-based scent is often considered more “personal” in that it is easier to associate the scent with a particular animal as compared to the smell of urine that is often indistinguishable.

Another aspect of the invention concerns deployment via an attractant delivery device of the resulting bone product. As opposed to liquids that are simply applied to the ground or on tree bark or on other objects, the bone product of the invention is preferably suspended for some amount of time in air and propogated along the path of prevailing wind or wind-assisted device. Preferably, the bone product when introduced into the air is sufficiently fine to remain suspended in the air for appreciable periods of time to allow the scent of the bone product to travel distances to be encountered by game animals. In addition to use of the invention to attract like-species, e.g., deer bone product used to attract deer, the invention may be used to attract predators of the donor animal species used to create the bone product. For example, bears may be attracted to the scent given off when deer fight and therefore may be attracted to the source of the scent replicating fighting deer. To the extent deer and other game are attracted by visual stimulants, e.g., smoke, the invention may further employ means to produce a “smokey” look. For example, the introduction of the fine bone product powder into the air may be adapted to give off a “smokey” appearance even in the absence of fire or smoldering matter. Also, the powder attractant may be stored in a container that includes a top, such as a screw-top, that includes a compass for easy reference to wind direction.

In one alternative, the combined mixture may be put into liquid form, e.g., by adding water or other suitable liquid for mixing and suspending the powder into a solution. The liquid solution may be sprayed with a fine mist bottle having a spray nozzle. A flip lid bottle may also be used. In another alternative, the bone powder or a combined mixture may be processed into a gel form. For instance, a white petroleum jelly or “gel” may be used that has, e.g., a melting point of 75 degrees F. After melting the jelly, the bone powder or the combined mixture, e.g., one ounce, may be mixed into the melted petroleum and then poured into the bottle while it's still hot liquid. The gel or liquid-based substance retains the burnt smell associated with grinding antlers. In one embodiment, a misting device may be used to introduce the liquid-based bone product into the air with the fine particles traveling along the path of the wind. The bone product may be packaged in an aerosol can for delivery via a spray nozzle. A device may be used for either type of delivery device to elevate the output of the attractant delivery device, e.g., an extendable boom or telescoping handle/staff. In gel form, the natural effect of wind traveling across a substrate supporting the gel will cause the bone product to travel along with the wind. The gel may also be applied to tree bark or most any naturally occurring items. The bone product can be used with wicks, scent pads, wafers or any other various scent applications.

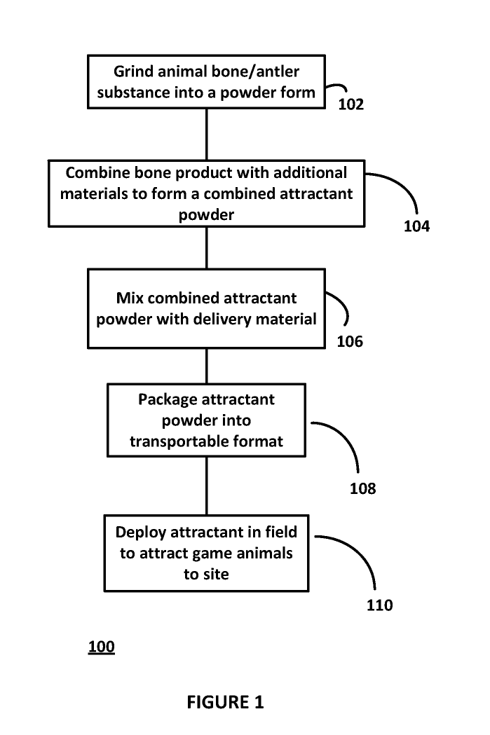

FIG. 1 is a flow chart showing an overview of a manufacturing process for producing and deploying an exemplary embodiment of the invention. In the first step, animal bone/antler material is processed by grinding the bone in a manner that causes and results in a burnt smell. The final product is, for example, a fine powder, shown in block 102 from FIG. 1. In addition to the bone product, other ingredients as described herein may be combined with the bone product, see step 104. Certain other processes may be performed on the bone product or on the combined bone product mixture to arrive at a final attractant product, 106. The final attractant product is packaged in a transportable format for storage and for delivery of the attractant, 108. The attractant product is then deployed in the field to attract game animals to a desired site, 110.

The final bone product mixture preferably comprises the combination of ingredients and respective portions as shown in TABLE 1 below. With the exception of the bone product, it is not necessary to include all or even a majority of the exemplary secondary ingredients shown in TABLE 1. Moreover, additional ingredients may be added to the mixture. Although ranges are also shown in TABLE 1, these are exemplary and do not limit the invention. The combination below provides enhanced properties as a game attractant. For instance, ¾ ounce of bone product may be combined with ¾ ounce talc powder and ½ ounce gland powder to yield a two-ounce portion of the attractant product.

TABLE 1

| Ingredient | % by Weight/Volume |
|---|---|
| Bone Product(s) | .375 |
| Talc powder | .375 |
| Gland powder | .25 |

In a first embodiment the invention provides a method for making a storable and deployable game attractant comprising: using a manufacturing process to grind an animal bone into a base bone powder, the base bone powder having a persistent odor that replicates a burnt antler smell associated with grinding antlers of male animals; processing the base bone powder into a storable and deployable attractant product; whereby the attractant product may be transported to a location and deployed for attracting game animals. The method may further comprise combining the base bone product with at least one other attractant. The method may include processing the base bone product to include applying the base bone product to one of a group consisting of wicks, scent pads, and wafers. The method may further comprise processing the attractant to include a cover scent adapted to cover the scent of a human.

In another embodiment the invention provides a game animal attractant composition comprising: a bone powder derived from the bone of a game animal ground to a powder form and processed to yield a fixed form attractant that when deployed exhibits an odor that replicates a burnt antler smell of a ruminant game animal.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the invention. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A method for making a storable and deployable game attractant comprising:
using a manufacturing process to grind an animal bone into a base bone powder, the base bone powder having a persistent odor that replicates a burnt antler smell associated with grinding antlers of male animals;
processing the base bone powder into a storable and deployable attractant product;
whereby the attractant product may be transported to a location and deployed for attracting game animals.

2. The method of claim 1, further comprising combining the base bone product with at least one of the group consisting of a talc-based substance, a gland powder, and an other animal attractant.

3. The method of claim 1, wherein the attractant product is processed so as to enable a persistent airborne presence when deployed.

4. The method of claim 1, wherein processing the base bone product includes applying the base bone product to one of a group consisting of wicks, scent pads, and wafers.

5. The method of claim 1, further comprising processing the attractant product to include a cover scent adapted to cover the scent of a human.

6. The method of claim 1 further comprises applying a burn promoting substance to promote deployment of the attractant product.

7. The method of claim 6, wherein the burn promoting substance is adapted to cause a smoking dispersal of the attractant product when a flame source is applied to the attractant product.

8. The method of claim 1, wherein the attractant product is processed into a form from the group consisting of a solid, a powder, a liquid, a gel, and a paste.

9. A method for making a game attractant comprising:
grinding animal bones in a manner that yields an odor consistent with a naturally occurring burnt antler smell produced when male animals grind opposing antlers when fighting one another;
processing the resulting ground animal bone into a storable, transportable and deployable attractant product, the attractant product when deployed adapted to attract game animals to a desired location.

10. The method of claim 9, further comprising combining the resultant ground animal bone with at least one of the group consisting of a talc-based substance, a gland powder, and an other animal attractant.

11. The method of claim 9, wherein the attractant product is processed so as to enable a persistent airborne presence when deployed.

12. The method of claim 9, further comprising applying the attractant product to one of a group consisting of wicks, scent pads, and wafers.

13. The method of claim 9 further comprising processing the attractant product to include a cover scent adapted to cover the scent of a human.

14. The method of claim 9 further comprises applying a burn promoting substance to promote deployment of the attractant product.

15. The method of claim 14, wherein the burn promoting substance is adapted to cause a smoking dispersal of the attractant product when a flame source is applied to the attractant product.

16. The method of claim 9, wherein the attractant product is processed into a form from the group consisting of a solid, a powder, a liquid, a gel, and a paste.

17. A game animal attractant composition comprising: a bone powder derived from the bone of a game animal ground to a powder form and processed to yield a fixed form attractant that when deployed exhibits an odor that replicates a burnt antler smell of a ruminant game animal.

18. The composition of claim 17 further comprising at least one of the group consisting of a talc-based substance, a gland powder, and an other animal attractant.

19. The composition of claim 17, wherein the fixed form attractant is in a form from the group consisting of a solid, a powder, a liquid, a gel, and a paste.

20. The composition of claim 17 further comprising a burn promoting substance adapted to cause a smoking dispersal of the attractant product when a flame source is applied to the attractant product.
